(19) United States
(12) Patent Application Publication
(10) Pub. No.: US 2026/0101418 A1
(43) Pub. Date: Apr. 9, 2026

(54) HEATING ELEMENT SEALING SYSTEM

(71) Applicant: Backer EHP Inc., Murfreesboro, TN (US)

(72) Inventor: Stacy V. Springer, Murfreesboro, TN (US)

(21) Appl. No.: 18/905,963

(22) Filed: Oct. 3, 2024

(51) Int. Cl. H05B 3/48; H05B 3/04

(52) U.S. Cl. CPC H05B 3/48; H05B 3/04

(57) ABSTRACT

Electric heating element sealing systems are disclosed. In one embodiment, an electric heating element includes a tubular sheath, an electrical insulator disposed inside the tubular sheath where the electrical insulator includes an end surface that is recessed from an end of the tubular sheath, a conformal coating disposed on the end surface to form a water vapor barrier, and a bushing positioned against the conformal coating and at least partially inside the tubular sheath. The conformal coating conforms to and bonds to adjoining surfaces, including at least at the bushing/electrical insulator interface.

### BACKGROUND

This disclosure relates generally to electric heating elements, and more particularly to electric heating elements for household appliances such as stovetops, ranges, ovens, and the like.

Electric heating elements convert electrical energy to heat energy. In the past, electric heating elements for use in stovetops, ranges, and ovens have been susceptible to moisture vapor intrusion therein. NFPA 70 requires household appliance manufacturers to ensure that all plug-in receptacles and hard-wired circuits rated for 250 volts or less must have GFCI circuit protection. To avoid a safety hazard, household appliance manufacturers attempt to seal various components of the electric heating elements to avoid water vapor intrusion therein. However, manufacturers have not been successful in ensuring water vapor does not migrate inside the heating element. In addition, prior sealing mechanisms of silicone oil require a curing period of at least 1 minute at an elevated temperature of approximately 600° F. to cure sealing materials, thus extending and/or complicating the manufacturing assembly process of electric heating elements.

Thus, there exists a need to solve these and other problems.

### SUMMARY

Disclosed herein are various embodiments of a sealing system for an electric heating element. In one embodiment, an electric heating element comprises: (i) a tubular sheath; (ii) an electrical insulator disposed inside the tubular sheath, the electrical insulator comprising an end surface; (iii) a cylindrical bushing positioned adjacent to the end surface of the electrical insulator, wherein a first portion of the bushing lies inside a swaged end portion of the sheath and a second portion of the bushing lies outside the sheath; and (iv) a water vapor barrier comprising a conformal coating disposed between the end surface of the electrical insulator and an end surface of the bushing, where the conformal coating is configured to fill one or more voids and/or channels between the bushing and the swaged end portion of the sheath.

The electrical insulator may include a magnesium oxide formulation. The conformal coating may include a silicone resin that is curable at temperatures ranging from room temperature to 60° C. The conformal coating may be disposed on the end surface of the electrical insulator. The conformal coating may be disposed on the end surface of the bushing. The conformal coating may be disposed between the bushing and the sheath.

In another embodiment, an electric heating element comprises: (i) a tubular sheath; (ii) an electrical insulator disposed inside the tubular sheath, the electrical insulator comprising an end surface that is recessed from an end of the tubular sheath; (iii) a conformal coating disposed on the end surface, the conformal coating comprising a water vapor barrier; and (iv) a bushing positioned against the conformal coating and at least partially inside the tubular sheath.

The electrical insulator may include a magnesium oxide formulation. The conformal coating may include a silicone resin that is curable at temperatures ranging from room temperature to 60° C. The tubular sheath may be swaged against the bushing. The conformal coating may additionally be disposed between the bushing and the sheath. The bushing may include a silicone material rated for operating to at least 250° C. or a PTFE material rated for operating to at least 260° C.

In another embodiment, an electric heating element comprises: (i) a tubular sheath; (ii) an electrical insulator disposed inside the tubular sheath, the electrical insulator comprising an end face; (iii) a bushing positioned coaxially with an end of the tubular sheath and proximal to the end face of the electrical insulator, wherein the bushing lies at least partially inside the end of the tubular sheath; and (iv) a conformal coating disposed between the bushing and the electrical insulator to seal the end face of the electrical insulator from water vapor intrusion.

The electrical insulator may include magnesium oxide. The conformal coating may include a silicone resin that is curable at temperatures ranging from room temperature to 60° C. The conformal coating may be disposed on the end face of the electrical insulator. The conformal coating may be disposed on the end surface of the bushing. The conformal coating may be disposed between the bushing and the sheath. The bushing may at least partially displace the conformal coating so as to fill microscopic gaps and voids. The end of the tubular sheath may be swaged against the bushing and the bushing may be wedged against the electrical insulator with the conformal coating therebetween.

### BRIEF DESCRIPTION OF THE DRAWINGS

FIG. 1A is a front elevation view of one embodiment of an electric heating element comprising an improved terminal end sealing system of the instant disclosure.

FIG. 1B is a right side elevation view of the electric heating element shown in FIG. 1.

FIG. 2 is a cross sectional view of the electric heating element shown in FIG. 1.

FIG. 3 is top partial perspective view of the electric heating element shown in FIG. 1.

FIG. 4 is a detailed cross sectional view of the electric heating element shown in FIG. 3.

### DETAILED DESCRIPTION

Although the figures and the instant disclosure describe one or more embodiments of an electric heating element sealing system, one of ordinary skill in the art would appreciate that the teachings of the instant disclosure would not be limited to these embodiments. It should be appreciated that any of the features of an embodiment discussed with reference to the figures herein may be combined with or substituted for features discussed in connection with other embodiments in this disclosure.

Various embodiments of an electric heating element sealing system are disclosed herein for use in appliances, such as electric cooktops, ranges, and ovens. Electric heating elements that incorporate improved sealing techniques of the instant disclosure reduce the time needed to manufacture the electric heating element because the sealing techniques do not require curing of sealing materials or components at extreme temperatures. In addition, electric heating elements that incorporate the improved sealing techniques of the instant disclosure eliminate leak paths for intrusion of water vapor to avoid reducing internal electrical insulation margins and to reduce the chance of triggering an open circuit by electrical GFCI receptacles or circuit breakers.

Major components of electric heating elements of the instant disclosure include an outer metallic sheath enclosing an electrical insulator with relatively high thermal conductivity and low electrical conductivity, such as magnesium oxide, that surrounds and electrically insulates an electrical conductor and/or terminal pin and an electric resistance wire positioned inside the sheath. To electrically terminate an end of the sheath having a terminal pin extending therefrom, a cylindrical, conformable bushing may be inserted over the terminal pin and inserted into the open end of the sheath provided that the end face of the electrical insulator lies inside the end of the sheath to receive an end face of the bushing thereagainst. Once at least partially inserted into the end of the circumferential sheath, the bushing may be held in place relative to the end face of the electrical insulator and relative to the inner diameter of the sheath by swaging and/or otherwise mechanically inwardly deforming the wall of the sheath against the outer perimeter of the cylindrical bushing. The bushing may comprise a silicone or a PTFE material to provide moisture vapor sealing along the external perimeter surface of the bushing relative to the inner surface of the end of the sheath. The bushing may become circumferentially compressed and reduced in diameter at the location where the sheath end is swaged or otherwise mechanically deformed.

To further ensure that water vapor does not reach the end face of the electrical insulator, a layer of conformal coating may be disposed on the end face of the electrical insulator to lie between and against the end face of the electrical insulator and the mating end face of the bushing, where the mating interface is recessed inside the end of the sheath. In some embodiments, a layer of conformal coating may be disposed on the mating end face of the bushing, either instead of on the end face of the electrical insulator or in addition to the end face of the electrical insulator. In some embodiments, a layer of conformal coating may be disposed on the outer surface of the bushing, either instead of or in addition to one or more of the locations previously described. In some embodiments, a layer of conformal coating may be disposed on the inner surfaces of a central, longitudinal aperture for sealing the aperture against the outer surfaces of the terminal pin. In some embodiments, a layer of conformal coating may be disposed on the inner surface of the end of the sheath, either instead of or in addition to the one or more locations previously described. In some embodiments, a layer of conformal coating may be disposed on the outer surfaces of the terminal pin to seal against the central, longitudinal aperture of the bushing. In some embodiments, a pre-assembly layer thickness of the conformal coating may range from about 0.001 inch thick to about 0.020 inch thick to achieve a post-assembly layer thickness of conformal coating about 0.001 inch thick to about 0.005 inch thick. In some embodiments, an interference fit exists between the terminal pin and the bushing aperture, and the interference fit is suitable for preventing moisture vapor penetration therethrough. A suitable conformal coating may be Dowsil brand conformal coating model number 1-2577 available from the Dow Chemical Company. All of the features of that conformal coating are incorporated by reference herein in their entirety. That particular coating is marketed as a medium viscosity silicone resin conformal coating that is curable at temperatures ranging from room temperature to 60° C. In addition, that particular coating when cured has a useful operating temperature of-45° C. to 200° C.

By disposing a conformal coating, such as a silicone resin, on the magnesium oxide or other electrical insulator prior to inserting the bushing inside the sheath, multiple possible water vapor leak paths can be eliminated. For example, the conformal coating may be configured to conform to the face of the bushing upon insertion of the bushing inside the sheath and against the face of the magnesium oxide insulation. In addition, the conformal coating may be at least partially displaced by the insertion of the bushing thereby filling any longitudinal or circumferential voids or channels that may form or otherwise exist between the inner surface of the swaged sheath end and the mating outer surface of the bushing. The conformal coating may, in at least some situations, form a bond between adjoining component surfaces.

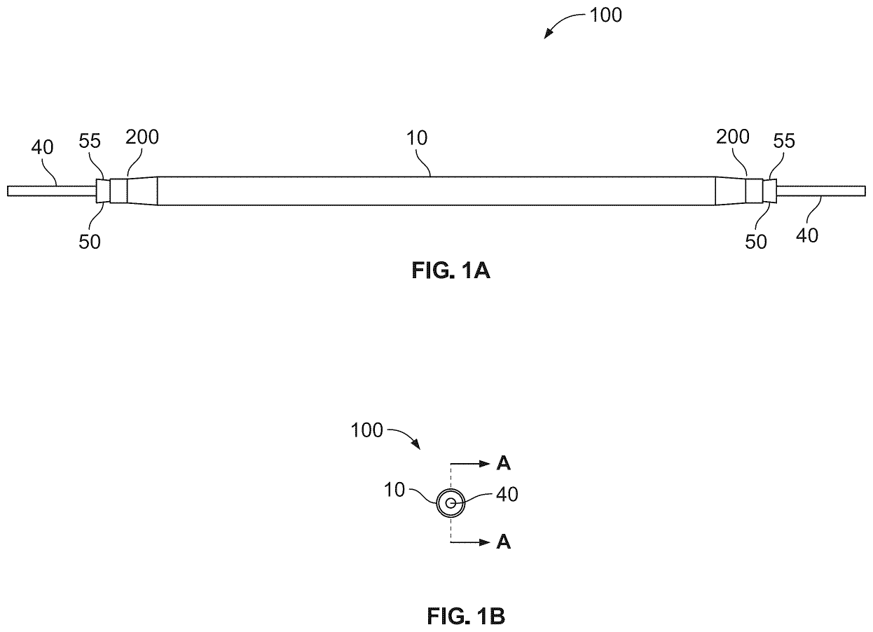

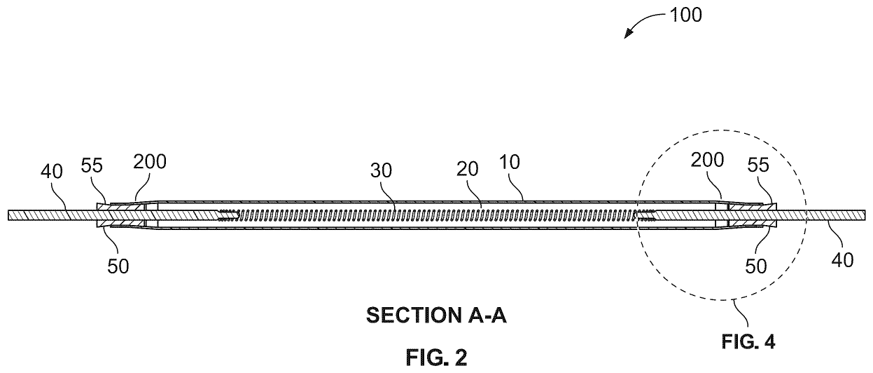

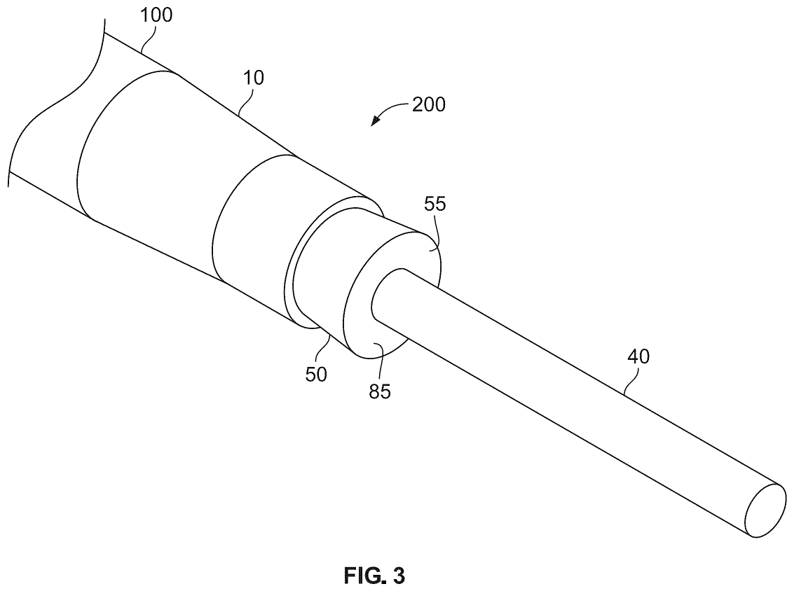

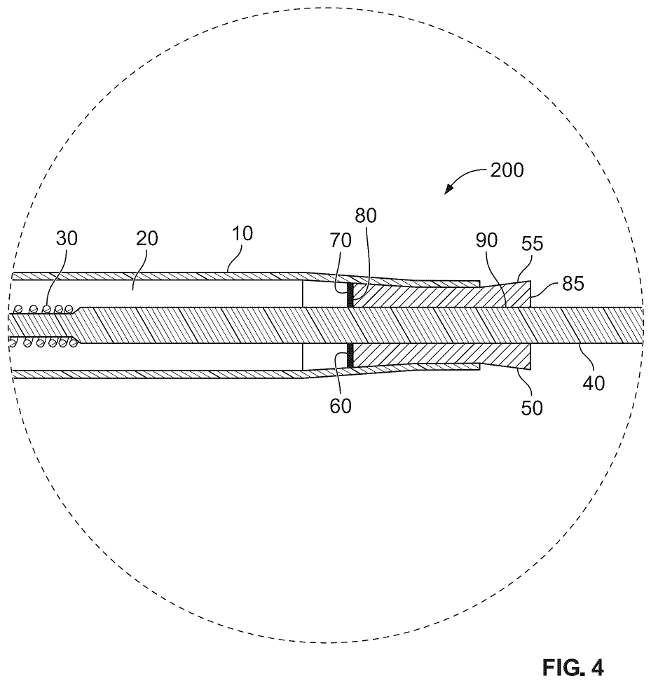

Turning now to the drawings and to FIGS. 1-4 in particular, there are shown various aspects of a representative electric heating element 100 comprising sealing system 200 of the instant disclosure. As illustrated in the figures, representative electric heating element 100 includes sheath 10, electrical insulation 20, electric resistance wire 30, terminal pin 40, and bushing 50. Sheath 10 may comprise any metallic tubular sheath for heating elements, such as aluminum, stainless steel, and the like. Electrical insulation 20 may comprise magnesium oxide, as described above, or any insulation material that is suitable for use as an electrical insulator between the electrically energizable components lying inside sheath 10 and sheath 10 itself. Electric resistance wire 30 may comprise any suitable resistance wire for creating heat upon exposure to an electrical current, such as nichrome or any other material or alloy for that purpose. Terminal pin 40 is configured to be connected to and extend from electric resistance wire 30 beyond a respective end of sheath 10. As shown in FIG. 4, electric insulation 20 is configured to lie inside the tube defined by the inner surface of sheath 10, and around electric resistance wire 30 and terminal pin 40 to act as a barrier to electrical conductivity from electric resistance wire 30 and/or terminal pin 40 to sheath 10.

Sealing system 200 of electric heating element 100 is configured to eliminate intrusion of water vapor past bushing 50 at all times, including during storage, transport, and use/operation. As shown in FIG. 4, sealing system 200 includes conformal coating 60 positioned between end face 70 of electrical insulation 20 and end face 80 of bushing 50 and acting as a conformal sealing surface therebetween.

To electrically terminate and seal one end of electric heating element 100, electrical insulation 20 comprising, for example, magnesium oxide or the like, is disposed and packed inside sheath 10 and around electric resistance wire 30 and terminal pin 40. Bushing 50 comprising a central aperture 90 may be inserted at least partially inside the end of sheath 10, over terminal pin 40, and against conformal coating 60. End of sheath 10 may then be swaged, crimped, or otherwise mechanically deformed to caused the inner surface of sheath 10 to inwardly and circumferentially deflect around the perimeter of sheath 10 at the axial location of the swage procedure. As shown in FIG. 4, terminal pin extends past end face 85 of bushing 50, and a tail portion 55 of the swaged bushing 50 extends past the end of sheath 10. After installation, bushing 50 is configured to cause conformal coating 60 to conform to adjacent surfaces and to fill voids along the interface between bushing 50 and electrical insulation 20 and between bushing 50 and sheath 10.

While specific embodiments have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. An electric heating element, comprising:
a tubular sheath;
an electrical insulator disposed inside the tubular sheath, the electrical insulator comprising an end surface;
a cylindrical bushing positioned adjacent to the end surface of the electrical insulator, wherein a first portion of the bushing lies inside a swaged end portion of the sheath and a second portion of the bushing lies outside the sheath; and
a water vapor barrier comprising a conformal coating disposed between the end surface of the electrical insulator and an end surface of the bushing, wherein the conformal coating is configured to fill one or more voids and/or channels between the bushing and the swaged end portion of the sheath.

2. The electric heating element of claim 1, wherein the electrical insulator comprises magnesium oxide.

3. The electric heating element of claim 1, wherein the conformal coating comprises a silicone resin that is curable at temperatures ranging from room temperature to 60°C.

4. The electric heating element of claim 3, wherein the conformal coating is disposed on the end surface of the electrical insulator.

5. The electric heating element of claim 3, wherein the conformal coating is disposed on the end surface of the bushing.

6. The electric heating element of claim 3, wherein the conformal coating is disposed between the bushing and the sheath.

7. An electric heating element, comprising:
a tubular sheath;
an electrical insulator disposed inside the tubular sheath, the electrical insulator comprising an end surface that is recessed from an end of the tubular sheath;
a conformal coating disposed on the end surface, the conformal coating comprising a water vapor barrier; and
a bushing positioned against the conformal coating and at least partially inside the tubular sheath.

8. The electric heating element of claim 7, wherein the electrical insulator comprises magnesium oxide.

9. The electric heating element of claim 7, wherein the conformal coating comprises a silicone resin that is curable at temperatures ranging from room temperature to 60°C.

10. The electric heating element of claim 7, wherein the tubular sheath is swaged against the bushing.

11. The electric heating element of claim 7, wherein the conformal coating is additionally disposed between the bushing and the sheath.

12. The electric heating element of claim 7, wherein the bushing comprises a silicone material rated for operating to at least 250° C. or a PTFE material rated for operating to at least 260° C.

13. An electric heating element, comprising:
a tubular sheath;
an electrical insulator disposed inside the tubular sheath, the electrical insulator comprising an end face;
a bushing positioned coaxially with an end of the tubular sheath and proximal to the end face of the electrical insulator, wherein the bushing lies at least partially inside the end of the tubular sheath; and
a conformal coating disposed between the bushing and the electrical insulator to seal the end face of the electrical insulator from water vapor intrusion.

14. The electric heating element of claim 13, wherein the electrical insulator comprises magnesium oxide.

15. The electric heating element of claim 13, wherein the conformal coating comprises a silicone resin that is curable at temperatures ranging from room temperature to 60° C.

16. The electric heating element of claim 13, wherein the conformal coating is disposed on the end face of the electrical insulator.

17. The electric heating element of claim 13, wherein the conformal coating is disposed on the end surface of the bushing.

18. The electric heating element of claim 13, wherein the conformal coating is disposed between the bushing and the sheath.

19. The electric heating element of claim 13, wherein the bushing partially displaces the conformal coating so as to fill microscopic gaps and voids.

20. The electric heating element of claim 13, wherein the end of the tubular sheath is swaged against the bushing and the bushing is wedged against the electrical insulator with the conformal coating therebetween.
